(19) United States
(12) Patent Application Publication
(10) Pub. No.: US 2006/0253866 A1
(43) Pub. Date: Nov. 9, 2006

(54) Mobile station assisted control and display of media content

(76) Inventors: Igor Danilo Diego Curcio, Tampere (FI); Jose Costa-Requena, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/404,564

(22) Filed: Apr. 13, 2006

Related U.S. Application Data
(60) Provisional application No. 60/671,157, filed on Apr. 13, 2005.

(51) Int. Cl. H04N 5/445; G06F 3/00; G06F 13/00

(52) U.S. Cl. 725/40; 725/39

(57) ABSTRACT

Equipment of use typically in a mobile station for instructing a consumer electronic device to record content, for transferring content from a first consumer electronic device to a second consumer electronic device, and for requesting that a consumer electronic device communicate content to the equipment.

### CROSS-REFERENCE TO RELATED APPLICATIONS

This application claims priority under 35 U.S.C. § 119(e) to U.S. Provisional Application No. 60/671,157 filed Apr. 13, 2005.

### TECHNICAL FIELD OF THE INVENTION

The invention relates to consumer electronic devices, such as televisions, digital video disk players, cellular phones, personal video recorders, or set top boxes. More specifically, the invention relates to control of consumer electronic devices by user electronic devices, such as a mobile device.

### BACKGROUND OF THE INVENTION

Electronic consumer devices provide a variety of content to consumers. However, it is not always possible for a consumer to view the content provided on the electronic consumer device. It is also not always possible for the consumer electronic device to receive content desired by a consumer, either because the consumer electronic device is not adapted to receive the desired content, or because the desired content is not readily available to the consumer electronic device. The consumer may be out of visual or audio range of the consumer electronic device, or at a completely separate location from the consumer electronic device. Therefore, there is a need for a way for a consumer to access content while away from the consumer electronic device, and to provide desired content to a consumer electronic device when not possible for various reasons.

Prior solutions to the above described problem have included scheduling the recording of content according to a time schedule or a program code. This solution presents significant drawbacks because the consumer must be in the physical presence of the consumer electronic device to schedule the recording of content. Since the consumer must be in the physical presence of the consumer electronic device, the consumer must have physical access to the consumer electronic device prior to the transmission of the content to the consumer electronic device in order to schedule recording of the content. It is not always possible for a consumer to have physical access to a consumer electronic device prior to the transmission of content that the consumer desires to receive. The prior solutions also fail to allow a consumer to continuously receive content if the consumer must leave the vicinity of the consumer electronic device. Furthermore, no prior solution has been provided to instruct the consumer electronic device in the vicinity of the consumer what content the consumer desires to receive based upon the content received by another consumer electronic device where the consumer was previously, or a user equipment device that is currently receiving content. Furthermore, it is currently not possible for a consumer to receive content from the consumer electronic device if the consumer is not near the consumer electronic device. The current invention addresses these problems, as will be apparent based on the following discussion.

### SUMMARY OF THE INVENTION

In a first aspect of the of the invention a method is provided which includes generating a schedule command that instructs a consumer electronic device to record content, and providing the schedule command for transmission to the consumer electronic device via a transmitter of a user equipment device.

Accordingly, the first aspect of the invention may also include providing the schedule command for transmission via at least one or any combination or a local area network, a wireless interface, general packet radio service, universal mobile telecommunications service, an internet connection, or a public switched telephone service connection.

In a second aspect of the invention a method is provided and includes receiving on a user equipment device a signal from a first consumer electronic device indicative of a source of content, and communicating the source of content to a second consumer electronic device from the user equipment device.

The method according to the second aspect of the invention may also include receiving the signal on the user equipment device from a first consumer electronic device via a wireless interface.

The method according to the second aspect of the invention may also include the user equipment device communicating the source of content to the second consumer electronic device via a wireless interface.

The method according to the second aspect of the invention may include displaying content from the source on the user equipment device at least until the source of content is communicated to the second consumer electronic device.

In a third aspect of the invention a method is provided and includes creating in a user equipment device a request to have a consumer electronic device send contact to the user equipment device, and providing the request for transmission to the consumer electronic device.

In a fourth aspect of the invention a method is provided and includes receiving content from a source in a user equipment device, connecting the user equipment device to a network, and forwarding content from the source via the user equipment device to at least one consumer electronic device connected to the network.

Corresponding equipment is also provided, including an apparatus operative according to each of the above aspects of the invention, individually or in combination, as well as respective computer program products (and also corresponding application specific integrated circuits), user equipment, and systems including the user equipment and consumer electronic equipment.

### BREIF DESCRIPTION OF THE DRAWINGS

The above and other objects, features and advantages of the invention will become apparent from a consideration of the subsequent detailed description presented in connection with accompanying drawings, in which:

FIG. 1 is a simplified block diagram according to a first embodiment of the invention.

FIG. 2 is a flowchart of a method for carrying out the first embodiment of the invention.

FIG. 3A is a diagram showing communication via a transmission path between a user equipment device according to the first embodiment of the invention and a consumer electronic device via a transmission path.

FIG. 3B is a diagram showing communication between a user equipment device according to the first embodiment of the invention and a consumer electronic device via a wireless local area network.

FIG. 3C is a diagram showing communication between a user equipment device according to the first embodiment of the invention and a consumer electronic device via general packet radio service and an Internet connection.

FIG. 4 is a block diagram showing dimensions of a schedule command according a aspect of the first embodiment of the invention.

FIG. 5 is a reduced block chart according to the second embodiment of the invention.

FIG. 6 is a flowchart showing the steps of a method for carrying out the second embodiment of the invention.

FIG. 7A is a diagram showing communication between a first consumer electronic device and a user equipment device according to the second embodiment of the invention via a wireless local area network.

FIG. 7B is a diagram showing communication between a first consumer electronic device and a user equipment device according to the second embodiment of the invention via a Bluetooth connection.

FIG. 8A is a diagram showing communication between a user equipment device according to the second embodiment of the invention and a second consumer electronic device via a wireless local area network.

FIG. 8B is a diagram showing communication between a user equipment device according to the second embodiment of the invention and a second consumer electronic device via a wireless local area network.

FIG. 9 is a reduced block diagram according to the third embodiment of the invention.

FIG. 10 is a flowchart showing the steps of a method for carrying out the third embodiment of the invention.

FIG. 11 is a flowchart showing the steps of a method for carrying out another aspect of the third embodiment of the invention.

### DETAILED DESCRIPTION OF THE INVENTION

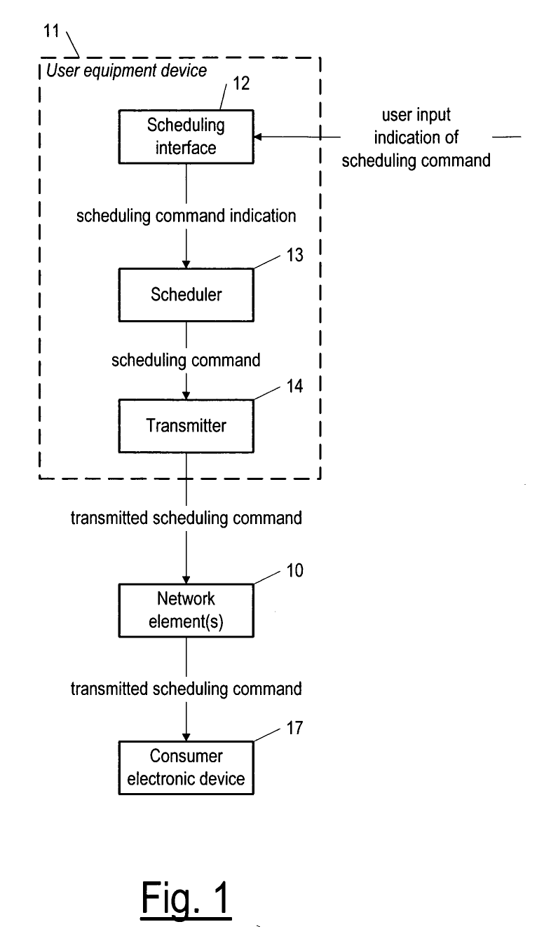

FIG. 1 shows a user equipment device 11 according to a first embodiment of the invention. The user equipment device 11 can be an electronic device such as a personal computer, a laptop personal computer, a personal digital assistant, a wireless station, such as a mobile station or a communication device, or the like. According to the first embodiment of the invention it becomes possible for a user to schedule the recording of content without the need for the user to be in physical proximity with the object where the recording is to take place prior to the start of the content.

As shown in FIG. 1, according to the embodiment of the invention shown there, the user equipment device 11 includes a scheduling interface 12 and a scheduler 13. The user equipment may also include a transmitter 14. The scheduling interface 12 is responsive to a user input and generates a schedule command. The schedule command instructs a consumer electronic device 17 to record content. The consumer electronic device 17 may be any electronic device capable of recording content, such as a personal video recorder, digital video recorder, a videocassette recorder, or the like. The content to be recorded on the consumer electronic device 17 includes any form of media communicated to a consumer and intended to be received by a consumer, and includes, but is not limited to, audio media, video media, or any combination of audio and video media. The scheduler 13 provides the schedule command to the transmitter 14 of the user equipment device for transmission to the consumer electronic device 17. It is understood that the schedule command is provided by the scheduler 13 to the transmitter 14 so that the schedule command may be transmitted via any suitable transmission path 10.

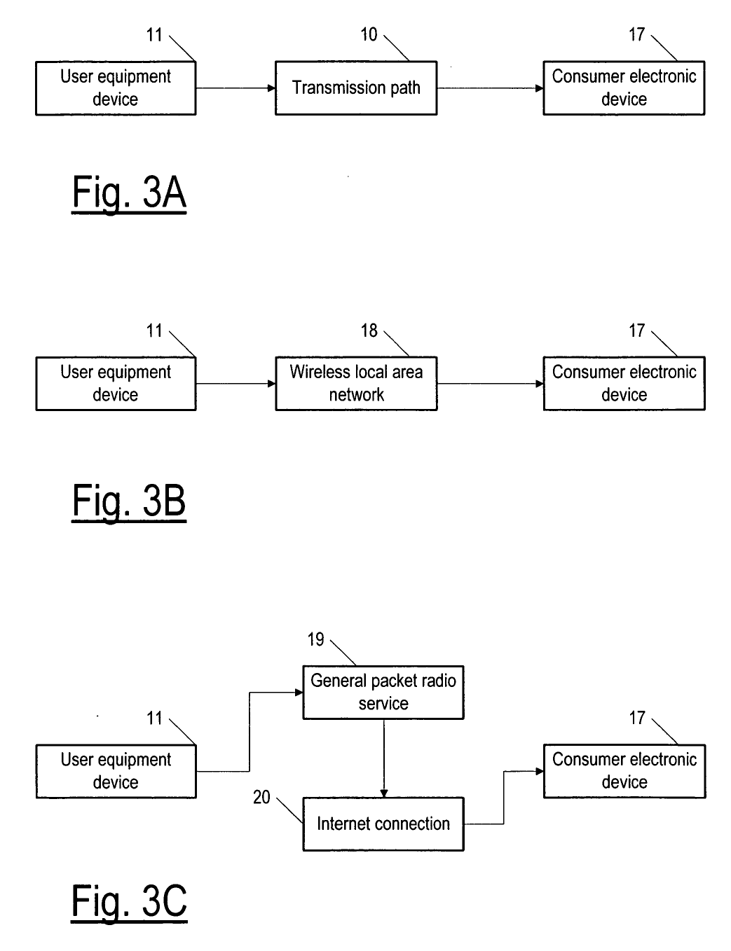

As shown in FIG. 3A, the transmitter 14 of the user equipment device 11 can transmit the schedule command to the consumer electronic device 17 via any suitable transmission path 10. The transmission path 10 can include any suitable radio access network, such as general packet radio service or universal mobile telecommunication system, and also can include a wireless interface, such as a wireless local area network, or a Bluetooth connection, and further can include an internet connection, a public switched telephone service, or the like. It is understood that any transmission path capable of transmitting the schedule command to the consumer electronic device 17 is contemplated by the invention. It is also understood that any combination of transmission paths can be used to transmit the schedule command to the consumer electronic device 17. As shown in FIG. 3B, by way of example, the transmitter 14 is within range of a wireless local area network 18 to which the consumer electronic device 17 is connected, and therefore the schedule command is transmitted via the wireless local area network 18. As shown in FIG. 3C, the transmitter 14 is not within range of the wireless local area network to which the consumer electronic device 17 is connected, so therefore the transmission occurs via general packet radio service 19, and then via an Internet connection 20.

FIG. 4 shows the schedule command in greater detail. It is understood that the schedule command can be generated manually, automatically, based on an electronic programming guide or search based. As shown in FIG. 4, the schedule command includes at least three parameters, such as a time 21, a location 22, and a content type flag 23. The time dimension 21 provides the consumer electronic device 17 information regarding when the consumer electronic device should record content. The time parameter 21 can be absolute, meaning that the exact time of the content desired to be recorded is provided by the time dimension 21, or relative meaning that the time the content is recorded is dependent upon when the schedule command is generated. The location 22 dimension of the schedule command provides which consumer electronic device the content is to be recorded on. The content type flag 23 indicates the type of content that is desired to be recorded. It is understood that the schedule command can be given using well known universal plug and play protocol.

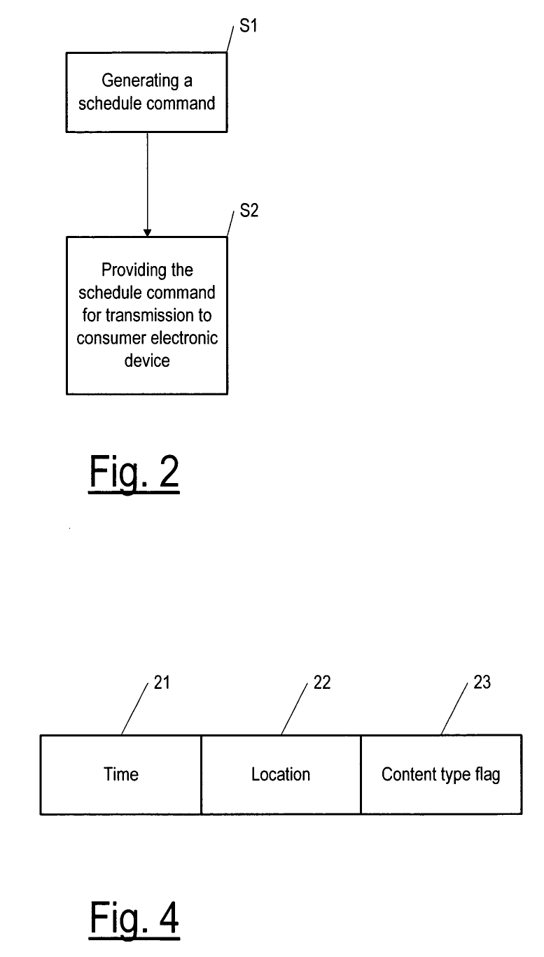

FIG. 2 shows a method in accordance with the invention. The method includes a first step S1, in which a schedule command is generated by a user equipment device, and a next step S2, in which the schedule command is provided for transmission to a consumer electronic device.

As explained above, the invention provides both a method and corresponding equipment consisting of various modules providing the functionality for performing the steps of the method. The modules may be implemented as hardware, or may be implemented as software or firmware for execution by a processor. In particular, in the case of firmware or software, the invention can be provided as a computer program product including a computer readable storage structure embodying computer program code—i.e. the software or firmware—thereon for execution by a computer processor.

FIG. 5 shows a user equipment device 30 according to a second embodiment of the invention. The user equipment device 30 can be an electronic device such as a personal computer, a laptop personal computer, a personal digital assistant, a wireless station, such as a mobile station or a communication device, or the like.

The user equipment device 30 includes a receiver 31 and a communicator 32. The receiver is configured to be responsive to a signal from a first consumer electronic device 33. The signal from the first consumer electronic device 33 indicates source of content. The first consumer electronic device 33 can be any electronic device capable of displaying content to a consumer, and includes, but is not limited to televisions, personal video recorders, personal computers, laptop computers, stereos, media players, or the like. Content is understood to include any form of media communicated to a consumer and intended to be received by a consumer, whether in digital or analog format, and includes, but is not limited to, audio media, video media, or any combination of audio and video media. Source of content is understood to include any object, entity or medium that communicates or broadcasts content to a consumer. By way of example, a source of content could include a particular television station providing content to a consumer, and a source of content can also include a consumer electronic device such as a personal video recorder providing previously recorded content to the consumer. The communicator 32 of the user equipment device 30 communicates the source of content to a second consumer electronic device 34. The second consumer electronic device 34 can be any electronic device capable of displaying content to a consumer, and includes, but is not limited to televisions, personal video recorders, personal computers, laptop computers, stereos, media players, or the like. In this manner, it becomes possible for the second consumer electronic device 34 to display the same source of content as the first consumer electronic device 33. Furthermore, the user equipment device 30 may also include a display 37 for displaying content from the source of content before the source of content is communicated to the second consumer electronic device 34. The display 37 allows a user to continue to receive content from the source when the user is out of physical proximity with the first consumer electronic device 33, and before the user comes within physical proximity of the second consumer electronic device 34. In this manner, it becomes possible for the user to continuously receive content from the source without missing any content.

It is also understood that the above described invention can be carried out using well known universal plug and play protocol between the user equipment device 30 and the first consumer electronic device 33 and the second consumer electronic device 34. It is also understood that the invention encompasses receiving content on the user equipment device from the source based on the signal from the first consumer electronic device 33, without the user equipment device communicating the source of content to the second consumer electronic device 34. It is also understood that the user equipment device may receive content directly from the source of content, without first receiving a signal from the first consumer electronic device. Then the user electronic device communicates the source of content to the second consumer electronic device when the user equipment device comes close to the second consumer electronic device. By way of example, and in no way limiting, the user equipment device is receiving content from a source of content, such as digital video broadcasting, and when the user equipment device enters a network to which the second consumer electronic is associated with, the user equipment device forwards the source of content to the second consumer electronic device.

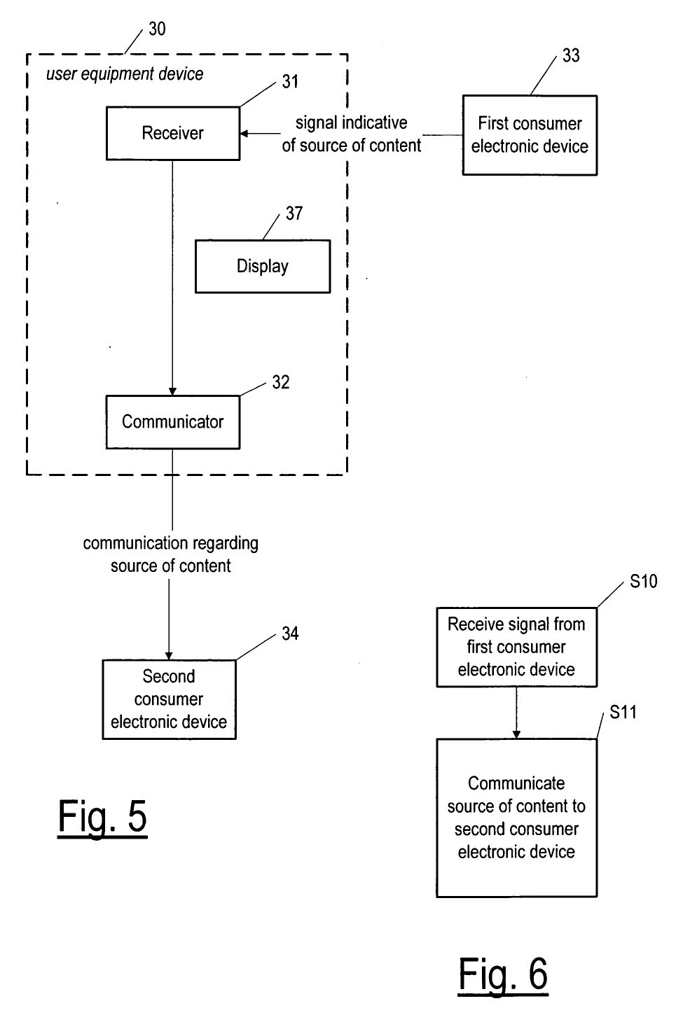

FIG. 6 provides a method for carrying out the second embodiment of the invention. The method is accomplished by a step S10 of receiving a signal indicative of a source of content from a first consumer electronic device, and a step S11 of communicating the source of content to a second consumer electronic device.

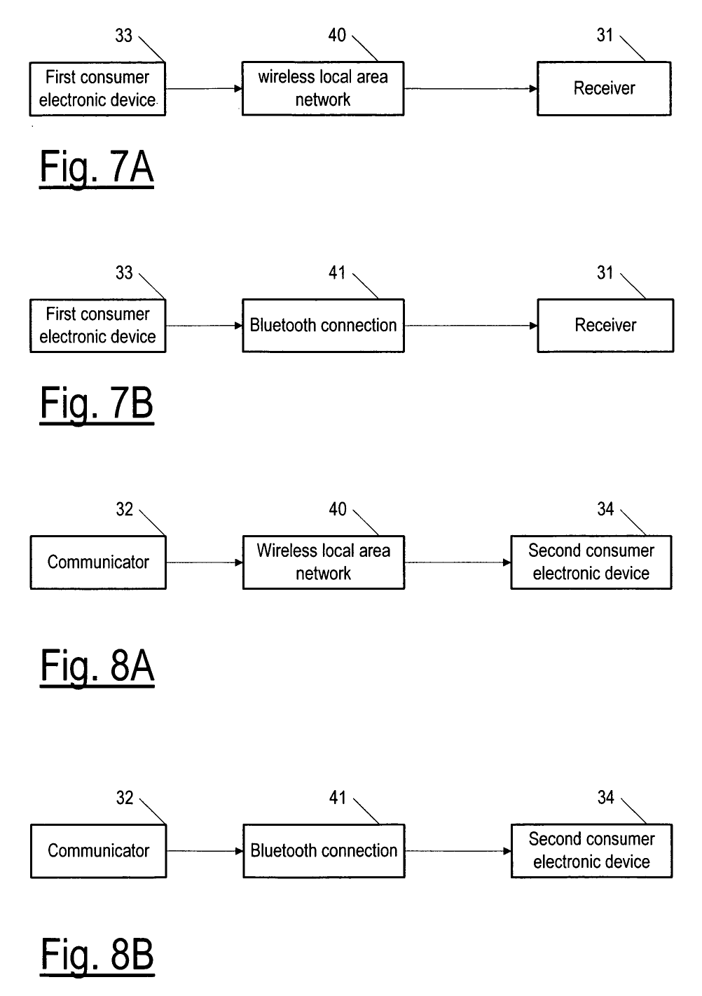

FIGS. 7A and 7B show various transmission paths by which the signal indicative of a source of content can be transferred from the first consumer electronic device 33 to the receiver 31. FIG. 7A shows the signal indicative of a source of content transferred over a wireless interface, such as a wireless local area network 40. FIG. 7B shows the signal indicator of a source of content transferred over a wireless interface, such a Bluetooth connection 41. It is understood that the first consumer electronic device 33 can communicate to the receiver 31 by any suitable transmission path.

FIGS. 8A and 8B show examples of transmission paths by which the source of content can be transferred from the communicator 32 to the second consumer electronic device 34. FIG. 8A shows the source of content transferred over a wireless interface, such as a wireless local area network 40. FIG. 8B shows the source of content transferred over a wireless interface, such as a Bluetooth connection 41. It is understood that the communicator 32 can transfer the source of content to the second consumer electronic device 34 by any suitable transmission path. It is also understood that the transfer of the signal indicative of a source of content can be transferred to the receiver 31 by one transmission path, such as wireless local area network 40, and the source of content can be transferred from the communicator 32 to the second consumer electronic device 34 by a different transmission path, such as a Bluetooth connection 41. It is also understood that the transmission paths used for each transfer can be the same type of transmission path, for example a Bluetooth connection 41 can be used to transfer the signal indicative of a source of content from the first consumer electronic device 33 to the receiver 31, and to transfer the source of content from the communicator 32 to the second consumer electronic device 34.

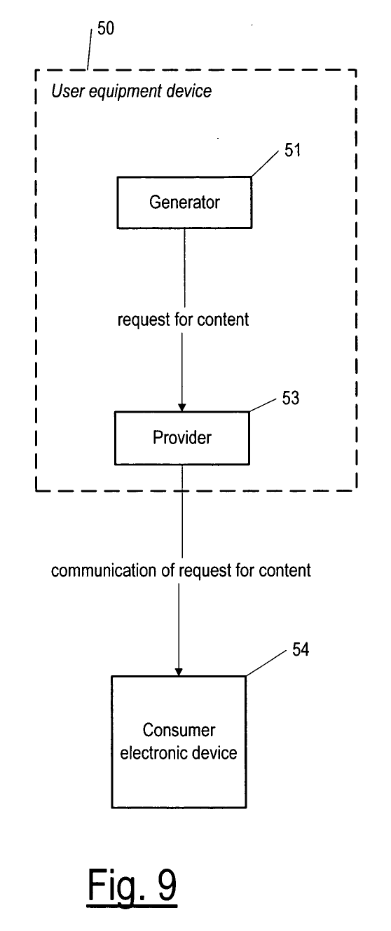

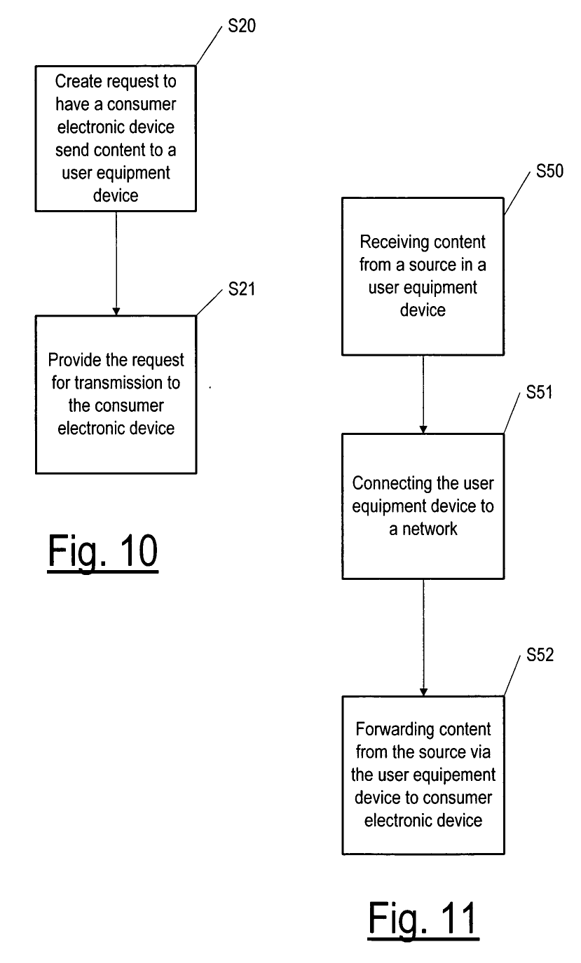

FIG. 9 shows a user electronic device 50 according to a third embodiment of the invention. As discussed previously, the user electronic device 50 can be an electronic device such as a personal computer, a laptop personal computer, a personal digital assistant, a wireless station, such as a mobile station or a communication device, or the like.

According to a third embodiment of the invention the user electronic device 50 includes a generator 51 and a provider 53. The generator 51 generates a request 52 to have a consumer electronic device 54 send content to the user electronic device 50. As discussed previously, it is understood that the consumer electronic device 54 can be any electronic device capable of displaying content to a consumer, and includes, but is not limited to televisions, personal video recorders, personal computers, laptop computers, stereos, media players, or the like. As also was discussed previously, content is understood to include any form of media communicated to a consumer and intended to be received by a consumer, whether in digital or analog format, and includes, but is not limited to, audio media, video media, or any combination of audio and video media. The user electronic device 50 also includes a provider 53 which provides the request 52 for transmission to the consumer electronic device 54. The third embodiment of the invention allows a user to receive content on the user electronic device 50 from locations remote from the consumer electronic device 54.

It is understood that according to the third embodiment of the invention, the user equipment device can act as a quality of service bridge between a source of content, such as digital video broadcasting, internet protocol television, or the like, and a network to which the consumer electronic device is connected, such as a home network. This allows the source of content to be forwarded to any consumer electronic device which is connected to the home network. It is understood that the user equipment device is able to map the quality of service requirements received from the source of content to the quality of service manager in the home network. By way of example, it is understood that the source of content may contain wireless local area network 802.11 quality of service policy, or the like, and the home network may contain universal plug and play quality of service policy, or the like.

FIG. 10 shows a method for carrying out the third embodiment of the invention. The method includes a step S20 of creating a request to have a consumer electronic device send content to a user equipment device, and a step S21 of providing the request for transmission to the consumer electronic device.

FIG. 11 shows a method for carrying out another aspect of the third embodiment of the invention. The method includes a step S50 of receiving content from a source on a user equipment device, a step S51 of connecting the user equipment device to a network, such as by way of example a home network, and a step S52 of forwarding the source of content via the user equipment device to a consumer electronic device connected to the network.

The functionality described above as provided by the invention can be implemented as software modules stored in a non-volatile memory of a device such as a mobile station, and executed as needed by the device (or more specifically, an operating system of the device) copying all or part of the software into executable RAM (random access memory). Alternatively, the logic provided by such software can also be provided by an ASIC (application specific integrated circuit). In case of a software implementation, the invention provided as a computer program product including a computer readable storage structure embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method comprising:
generating a schedule command that instructs a consumer electronic device to record content; and
providing the schedule command for transmission to the consumer electronic device via a transmitter of a user equipment device.

2. The method of claim 1, wherein the user equipment device provides the schedule command for transmission via at least one or any combination of a local area network, a wireless interface, general packet radio service, universal mobile telephone service, an Internet connection, or a public switched telephone service connection.

3. The method of claim 1, wherein the schedule command comprises a time dimension, a location, and a content type flag.

4. An apparatus comprising:
a scheduling interface responsive to a user input indicating a schedule command for instructing a consumer electronic device to record content; and
a scheduler responsive to the schedule command, and configured to provide the schedule command to a transmitter for communicating the schedule command to the consumer electronic device.

5. The apparatus of claim 4, wherein the apparatus provides the schedule command for transmission via at least one or any combination of a local area network, a wireless interface, general packet radio service, universal mobile telephone service, an Internet connection, or a public switched telephone service connection.

6. The apparatus of claim 4, wherein the schedule command comprises a time dimension, a location, and a content type flag.

7. The apparatus of claim 4, wherein the apparatus further comprises a user equipment device.

8. An apparatus comprising:
means, responsive to a user input indicating a schedule command for instructing a consumer electronic device to record content, configured to provide a schedule command; and
means, responsive to the schedule command, configured to provide the schedule command to a transmitter of the apparatus for communicating the scheduling command to the consumer electronic device.

9. A system comprising:
a user equipment device;
a consumer electronic device; and
a communication network with the user equipment device comprising the apparatus as in claim 4.

10. A computer program product comprising a computer readable storage structure embodying computer program code thereon for execution by a computer processor, wherein said computer program code comprises instructions for performing a method according to claim 1.

11. A method comprising:
receiving on a user equipment device a signal from a first consumer electronic device indicative of a source of content; and
communicating the source of content to a second consumer electronic device from the user equipment device.

12. The method of claim 11, wherein the user equipment device receives the signal from the first consumer electronic device via a wireless interface.

13. The method of claim 11, wherein the user equipment device communicates the source of content to a second consumer electronic device via a wireless interface.

14. The method of claim 11, further comprising displaying content of the source on the user equipment device at least until the user equipment device communicates the source of content to the second consumer electronic device.

15. An apparatus comprising:
a receiver responsive to a signal from a first consumer electronic device indicative of a source of content; and
a communicator configured to communicate the source of content to a second consumer electronic device.

16. The apparatus of claim 15, wherein the receiver is configured to receive the signal from the first consumer electronic device via a wireless interface.

17. The apparatus of claim 15, wherein the communicator is configured to communicate the source of content to the second consumer electronic device via a wireless interface.

18. The apparatus of claim 15, wherein the apparatus further comprises a display configured to display content from the source at least until the source of content is communicated to the second consumer electronic device.

19. The apparatus of claim 15, wherein the apparatus further comprises a user equipment device.

20. An apparatus comprising:
means responsive to a signal from a first consumer electronic device indicative of a source of content; and
means for communicating the source of content to a second consumer electronic device.

21. A computer program product comprising a computer readable storage structure embodying computer program code thereon for execution by a computer processor, wherein said computer program code comprises instructions for performing a method according to claim 11.

22. A method comprising:
creating in a user equipment device a request to have a consumer electronic device send content to the user equipment device; and
providing the request for transmission to the consumer electronic device.

23. An apparatus comprising:
a generator configured to generate a request to have a consumer electronic device send content to the apparatus; and
a provider configured to provide the request for transmission to the consumer electronic device.

24. A method comprising:
receiving content from a source in a user equipment device;
connecting the user equipment device to a network; and
forwarding content from the source via the user equipment device to at least one consumer electronic device connected to the network.

25. An application specific integrated circuit provided so as to operate according to a method according to claim 1.

26. An application specific integrated circuit provided so as to operate according to a method according to claim 11.

27. An application specific integrated circuit provided so as to operate according to a method according to claim 22.
